(19) United States
(12) Patent Application Publication
(10) Pub. No.: US 2026/0061948 A1
(43) Pub. Date: Mar. 5, 2026

(54) Truck Bed Multi-System having Drawer, Bike, Ramp, Table, and Step Features

(71) Applicant: Jeffrey W. Bradsher, Shelby Twp, MI (US)

(72) Inventor: Jeffrey W. Bradsher, Shelby Twp, MI (US)

(21) Appl. No.: 19/313,882

(22) Filed: Aug. 29, 2025

Related U.S. Application Data
(60) Provisional application No. 63/688,795, filed on Aug. 29, 2024.

(51) Int. Cl. B60R 13/01; A47B 5/02; A47B 5/06; B60P 1/43; B60R 3/00; B60R 9/10; B62D 33/03

(52) U.S. Cl. CPC B60R 13/01; A47B 5/02; A47B 5/06; B60P 1/433; B60R 3/007; B60R 9/10; B62D 33/03; B60R 2013/016

(57) ABSTRACT

The disclosure presents a multi-functional truck bed system that can be used with a short bed pickup truck while maximizing the cargo space available. A full functioning pull out drawer/tray with multi-use purposes can handle large loads, roll with minimal effort and have safety features such as anti-tip, anti-fallout, and locking feature to inhibit rolling on a grade. The embodiments include repurposing hardware that consists of the drawer/tray system into a two-place bike holder, a light duty ramp, a table and a step. The hardware is below the drawer/tray so as to maximize the cargo space in the truck bed. The drawer/tray system is non-intrusive, and it can be removed from the truck bed quickly without tools so that a driver can use the truck bed as it was intended.

### CROSS REFERENCE TO RELATED APPLICATIONS

This application claims the benefit under 35 U.S.C. § 119(e) of U.S. Provisional Application No. 63/688,795, entitled “Truck Bed Multi-System having Drawer, Bike, Ramp, Table, and Step Features,” filed Aug. 29, 2024; the disclosures of which are incorporated, in their entirety, by this reference.

### BACKGROUND

There is an unrelenting effort to add utility to pickup trucks. From OEM's you have, tailgate options, multi-function tailgate, storage bins etc. Then you have aftermarket ramps, steps, drawers, trays, campers, storage racks, bike racks, tool organizers, etc. In recent years the Crew Cab light duty pickup with the short box has become dominant. Residential customers are leading the way on these purchases. There are quite a few drawer and tray slides available but they each have their respective drawbacks. Most are intrusive, require mounting, drilling, etc. They are one dimensional. They are great for tools, wire, generators, feed, etc., but over engineered for groceries, golf bags, coolers, and luggage. You would not install them in a Lease truck because of the drilling and mounting. More importantly, most are not multifunctional, which is desirable.

The Table For Truck Bed Patent U.S. Pat. No. 5,090,335 is a table on wheels that fits into a truck bed. The table could be used as a tray while the wide casters find purchase on the box bed ribbed floor. When extended out, hardware for a table that is mounted under the tray can be dropped down giving a usable table up to 8 feet long. The entire, folded up assembly could be dropped to the ground on one end and tied to the tailgate on the other end turning into a light duty ramp.

There are inherent disadvantages to this system for short bed pickups. It was designed only for a box bed of 8 feet in length. In regard to the ramp, eight feet is not long enough span to get the angle manageable for use. In regard to the drawer rollers on the box, the rollers need to land on the upper portion of the box floor ribs and then those ribs need to be clear of any debris, else the wheels are inhibited. The wheels will also need to make the transition past the box floor and onto the tailgate when extended out at least half-way. This will require a lift of the assembly which is challenging to get loaded.

US Patent Publication No. 20160107560A1 titled Retractable Cargo Box Assembly for a Truck Cargo Bed, also has linear wheels attached to the underside of the box. There is no application for it to be a ramp or table. It does have inherent challenges with having rollers roll along the box bed especially when transitioning to the tailgate.

US Patent Publication No. US20080265603 titled Sliding Platform For a Pickup Truck, solves the roller's issue by having sets of wheels run inside a track on frame that is mounted to floor of the box. It addresses the inherent challenges of rollers running along the box floor. It can extend out for access to the entire tray. It requires drilled holes in the front box wall, and is easier to remove than a frame that is bolted. However, this system does not provide the preferred multi-functionality that is desired in the marketplace.

US Patent Publication No. 20200406986A1 titled Modular Light Weight Universal Non-Invasive Retractable Storage System For a Truck Bed, Van and/or a Trailer Bed, uses a drawer system. Instead of the wheels rolling inside a track the wheels are stationary and the drawer sides roll between them. It is non-intrusive and is adjustable to fit most boxes. However, this system lacks the desired multi-purpose functionality.

US Patent Publication No. 20130094931 titled Extending Vehicle Platform Having a Built in Ramp, has a slidable tray with two extendable ramps underneath. The drawer slides on rails and when it is fully extended it can lock and the ramps can be pulled out. The problem is that the ramp length is limited by the box length. With the tailgate edge more than 3 feet high the ramps are at more than 30 degree angle making this system difficult use. For example, it would be difficult for an operator to push cargo up that steep of an angle.

U.S. Pat. No. 5,649,731 titled Workbench on Vehicle Mounted Tracks, is a guided roller system. The rail system is a roller and may be fastened to a truck. The legs are hinged under the tray so when it is extended, they can be rotated down. The problem with this design is that the system can't be removed easily when someone wants to use the truck bed, and it does not provide a ramp or a step.

U.S. Pat. No. 11,951,948 titled Deployable Step For Vehicle With Extendable Cargo Bed, is a dual function utility device that has a step for accessing the box bed built into the bottom of an extendable tray. The tray is designed for being able to access the cargo in the truck bed. The steps are needed if you need to remove the tray for using the truck for another purpose (i.e., hauling and removing mulch, topsoil, etc.). This system lacks the multi-functionality features that are desired in the marketplace.

### OVERVIEW

The present disclosure provides a light duty system that has multi-functionality all in one device. Instead of single purpose or even dual purpose, it provides a multi-purpose drawer/tray/bedslide/ramp and two position bike holder that is not permanently affixed to the truck bed or frame. It can be removed quickly so one can use the bed as it was intended from the OEM. One can convert the bed slide into a 10 foot long, 20 degree, light duty ramp. One can convert the drawer/tray/bedslide into a 22 square foot table. One can convert the drawer/tray/ bedslide to include two full steps for accessing the box bed. Further, because of the need for reconfiguring, the system works well with pick up boxes that have a spray on bedliner, the roller sections while removing and installing tend to scratch up the paint on the box bed.

The drawer/tray/bedslide uses about 20 conveyor rollers in two different roller sections. This arrangement disperses the weight of the load and it starts moving with less than two pounds of pull when empty. The drawer has an anti-tip, an anti-fallout and a locking mechanism for when the truck is on a grade. This design allows the drawer to roll smoothly such that it will start moving when on an incline and the tailgate is put down. It has walls on three sides and a sectional wall toward the tailgate end of the tray. It can extend out 44 inches from its stored position which brings the end of the tray 18 inches past the tailgate. The box is protected by one inch foam mounted on the front of the tray. This cushions it when returning the tray to store position and it enables the tray to be held firmly in transit.

A two-position bike holder consists of two slots cut into the tray that are designed for a mountain bike (or a motorcycle). The rollers are configured such that the rear wheel of the bike utilizes the depth of the roller section to hold the rear wheel from moving fore/aft or side to side. While the bike is simply placed in the receiver it is held firmly by the bike anchor. The bike anchor is a rigid piece with a rubberized clamp. It affixes to a tonneau cover clamp so it is adjustable fore and aft to line up with the tube on the bike. The rubberized clamp wraps around the tube for a flexible hold. The bike anchor can be rotated under the box rail when not in use.

The light duty ramp consists of two 5-foot roller sections connected and spans 10 feet. The angle of ascent is less than 20 degrees. It is positively held in position so that the ramp cannot slip up or fall off the tailgate. It can handle loads of about 300 lbs and a width of 34 inches. The configuration is perfect for rolling devices such as bbq grills on wheels, push lawn mowers, edgers and even snow blowers.

The base for the table consists of the two 5-foot roller sections tied together side by side. The back of the table is supported by the tailgate. It is affixed to the bed of the truck via chain to the lower tie downs. The front of the table has two swing down legs that are stored in the C channel of the conveyor sections. The tabletop is the drawer/tray/bedslide flipped upside down onto the conveyor sections.

The step may be comprised of two steps. The upper step is one of the 5 foot conveyor sections held horizontally. One end of the upper step is held there by chain attached to the boxes lower tie down. The other side of the upper step is held horizontally by the second conveyor section which is vertical to the ground. The sections are then clamped together. The first step is incorporated into an anti-fallout piece that is in the front of the box bed. The step is then stabilized by pinning the horizontal step into a stabilizer bar that is inserted into the Reese hitch of the pickup.

### BRIEF DESCRIPTION OF THE DRAWINGS

FIG. 1 is a perspective view of the truck bed drawer/tray/slide system when the tray is in the deployed position and the truck tailgate is down;

FIG. 2 is a bottom view of the tray;

FIG. 3 is a front perspective view of the deployed truck bed drawer/tray/slide system;

FIG. 4 is a rear perspective view of the non-deployed truck bed drawer/tray/slide System;

FIG. 5 is an enlarged perspective view of the tray back stop, showing how the back stop sits into position;

FIG. 6 is an enlarged view showing how the Anti Fallout Board was notched to receive the lower tie down at the front of the box. This shows how the Anti Fallout Board is locked into the box and keeps the tray from falling out of the pick-up box inadvertently;

FIG. 7 is a review view of the two-place bike holder;

FIG. 8 is a closeup view of the bike slot;

FIG. 9 is a close-up view of the bike anchor crossbar with a rubber clamp;

FIG. 10 is a close-up view of the bike anchor crossbar attached to the tonneau clamp;

FIG. 11 is a side view of the ramp;

FIG. 12 is a top view of the ramp in the deployed position;

FIG. 13 is another side view of the ramp shown connected to a truck bed;

FIG. 14 is an end view of the ramp;

FIG. 15 is a close-up view of how the bolt washer and nut is deployed through the leg, connector board and roller section;

FIG. 16 is a close-up view of how the carabiner and the anti-forward pins hold the ramp solidly so it can't fall off the tailgate while in use;

FIG. 17 is a perspective view of the table in the deployed position;

FIG. 18 is a top view of the table in the deployed position;

FIG. 19 is a close-up view of how the table legs are stored in the C channel of the roller sections using the bolt, nut, washer and spring;

FIG. 20 is a close-up view of the table leg deployed and held firmly by the bolt, nut, spring, washer and angled brace;

FIG. 21 is a perspective view of the step in the deployed position;

FIG. 22 is a top view of the step in the deployed position;

FIG. 23 is a side view of the step in the deployed position;

FIG. 24 is a rear view of the step in the deployed position;

FIG. 25 is perspective view of the tray shown deployed with goods in the tray;

FIG. 26 is a top view of the tray shown partially pulled out of the truck bed with the rollers shown underneath the tray;

FIG. 27 is a front view showing a bike mounted to the tray;

FIG. 28 is a top view showing a pair of bikes mounted to the tray;

FIG. 29 is a side view showing the ramp deployed with a person driving a snowblower up the ramp;

FIG. 30 is a perspective view showing the table deployed and connected to a tailgate;

FIG. 31 is a side view showing the table resting on the tailgate; and

FIG. 32 is a side view showing the steps deployed and a person carrying cargo into the back of a truck.

### DETAILED DESCRIPTION

A truck bed multi-purpose multi-functional system 100 includes at least five utilitarian features for use with a vehicle such as a pick up truck 102. The features include a pull out tray 104, a bike holder 200, a ramp 300, a table 400, and a step 500. The system 100 may be easily installed within a pickup truck bed 114, and removed from the bed, while being operable to minimize the amount of cargo space it requires.

The multi-function system 100 is intended to be an aftermarket purchase and it can be easily installed and easily transferable to other vehicles, such as trucks. It is not permanently mounted to the truck bed 114. It may be used with light duty vehicles. Alternative embodiments of this disclosure for OEM's would facilitate the need for more utility, much like the multi-function tailgates that are currently being produced today.

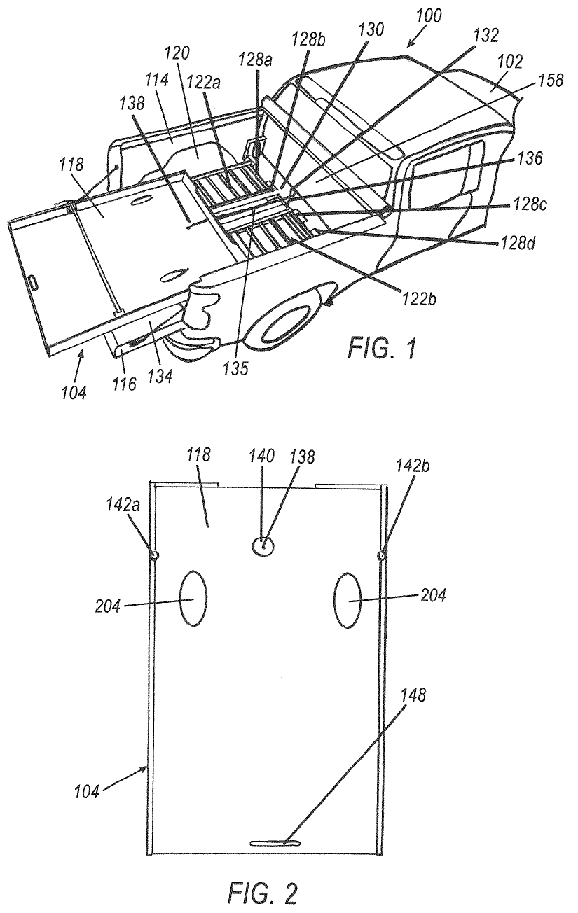

FIGS. 1-4 show one exemplary embodiment of the system 100 wherein the tray 104 is depicted. The tray 104 is shown in FIG. 1 in its extended position where it is extending out over the tailgate edge 116. The tray 104 includes a flat horizontal table 118 that is positioned within the wheel wells 120 of the truck bed 114. The tray 104 sits on top of two roller sections 122a, 122b. The two roller sections 122a, 122b have nylon bumpers 124a, 124b, 124c, 124d at a distal end and they are attached to vertical parts of a frame 126. The bumpers 124a-124d come in contact with crushable foam 128a, 128b, 128c and 128d (FIG. 1) that is located in a forward portion of the truck bed 114. The crushable foam 128a, 128b, 128c and 128d may be attached to a section of lumber referred to as the anti-fallout board/step 130 (see FIGS. 1 and 6). The anti-fallout board/step 130 also has a 3 ft section of crushable foam 132 attached to the front portion of the step 130. This protects the front of the truck bed 114 and allows for a certain amount of foam crush when the tailgate 134 is closed which in turns causes a pinching feature securing the two roller sections 122a and 122b in place during transport. The anti-fallout board/step 130 is notched to accept the lower tied downs of the pickup truck bed box itself. This locks it in with the truck bed box. A close up of the step 130 abutting the foam 132, and the foam 132 abutting a front wall of the truck bed 114, is seen in FIG. 6.

Finally, a strap 135 with thumb latch 136 is secured to the anti fallout board/step 130 and connected to an eyebolt 138 that is secured to the tray 118. The strap 135 dictates the maximum travel of the tray 104 fore and aft, it also acts as a safety feature in that it does not allow for the tray 104 to fall out of the pickup bed 114 if it was on grade or if the tailgate 134 was inadvertently left open.

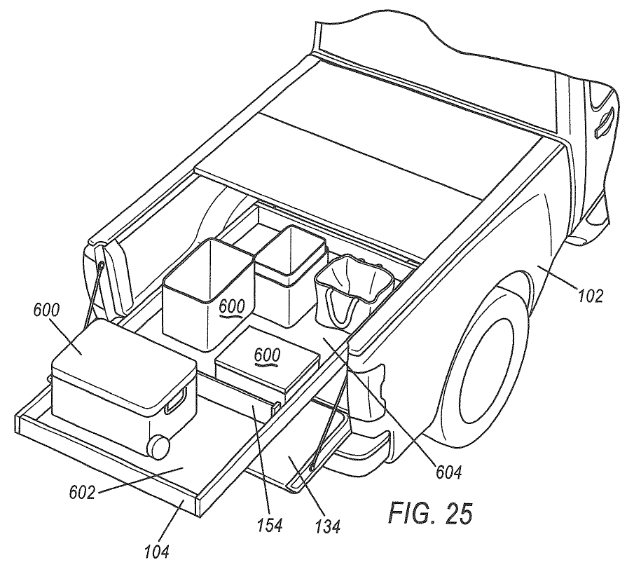

Referring to FIG. 2, the tray 104 is depicted from the underside. Fastener hardware 140 consists of a three inch fender washer and nut that connects to the eyebolt 138. The increase in surface area of the enlarged washer compared to a normal washer, aids to assist the tray 104 from damage in the event that the anti-fallout was engaged when under load. Also depicted in FIG. 2 are anti-tip washers 142a and 142b. The washers are mounted on the underside of the tray 104 sides. They extend down about ½ inch below the bottom of the tray. The anti-tip washers 142a and 142b traverse below the upper channel of the roller sections 122a and 122b. The anti-tip washers 142a and 142b ensure the tray 104 cannot tip to protect cargo 146 (FIG. 25) from falling off in the event that it was heavily loaded to the back. The finger protect handle 148 is a feature that does not allow the fingers to go through the tray 104. This is helpful because of the potential for a pinch point of the tailgate 134.

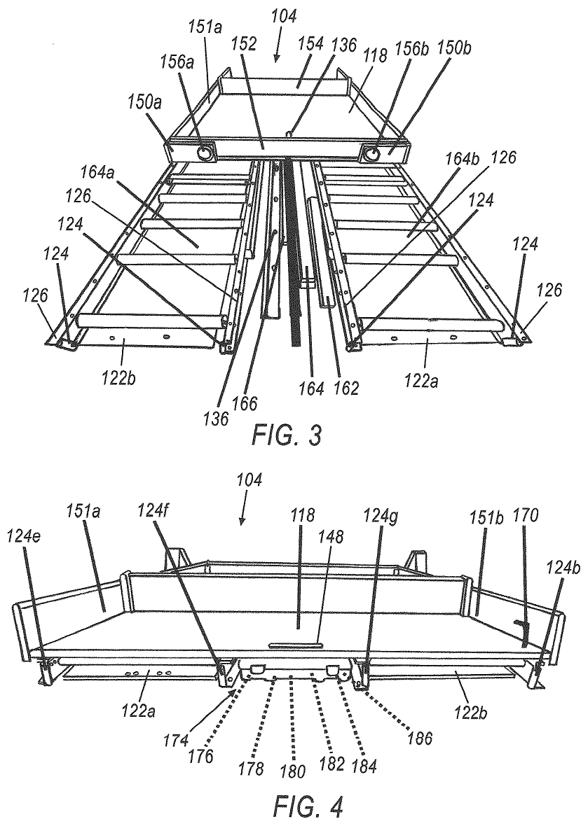

Referring now to the front view FIG. 3, the view depicts the tray 104 in its fully extended position. In regard to the construction of the tray 104, it has the table top 118, in the front two permanently held tray back pieces 150a and 150b, tray side walls 151a and 151b, a back stop 152, and a midstop 154. Secured to the tray back pieces 150a and 150b, are foam pieces 156a and 156b that line up with an outward rib of the front 158 of the pickup box or truck bed 114. The length of the tray 104 is designed so that when the tailgate 134 is closed, it crushes the foam 156 against the front of the bed 158 holding it securely while the truck 102 is in transit.

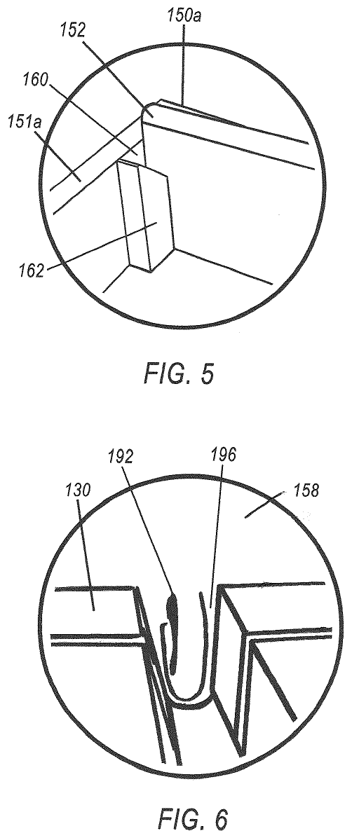

The tray back pieces 150a and 150b are part of the removable tray backstop 152 in which the tray backstop 152 is held securely in a channel 160 (FIG. 5) between the tray back 150a and 150b and a small angled support member 162, which permits easy placement and removal of the backstop 152. A close-up depiction of this is seen in FIG. 5 where the removable tray midstop 154 is received in a channel much like the tray backstop 154 is held in place in a channel 160. Forward ramp plates 164a and 164b are stored under the roller sections 122a and 122b.

Referring to FIG. 3, between the roller sections 122a and 122b is space to store the ramp leg short 162, ramp leg long 164, and middle table leg 166. It also provides space for the strap/thumb latch 136 to fold into when the tray 104 is in its stored position.

Referring back view FIG. 4, the tray sides 151a and 151b are designed so that the bottom of the sides are ½ inch below the bottom surface of the tray 104. This acts as a guide and it allows for the mounting of the anti-tip washers 142a and 142b. The roller sections 122a and 122b are designed such that the rollers are held by two opposing C channels. These channels have holes in the top of them. The tray 104 has a hole such that an Allen locking tool 170 can be placed through the tray 104 and through the roller section 122a to lock it in place. This is desirable when on grade, the tray 104 has the capability to roll out due to gravity. Much like the front of the roller sections 122a and 122b, the rear verticals are also covered with nylon bumpers 124e, 124f, 124g and 124h. These come into contact with the tailgate 134 when it is in the closed position as it compresses the crushable foam 128a, 128b, 128c and 128d and the crushable foam 132. The roller sections 122a and 122b are about 15 inches apart which is enough room to put a storage container 174. Finally, the rearward ramp plate/step plate 164a and 164b are depicted as stored under the roller sections 122a and 122b.

Referring to FIG. 4, between the roller sections 122a and 122b, there is space to have a hardware storage container for carabiners 176, chain 178, anti forward pins 180, ramp plate bolt/nuts 182, securing pins 184, Vise Grip clamps 186, and other tools.

FIG. 6 is a perspective view of the Anti Fallout Board 130 that was notched 196 to receive the lower tie down 192 at the front of the truck bed 158. This shows how the Anti Fallout Board 130 is locked into the truck bed 114 and keeps the tray 104 from falling out of the pick-up truck bed box inadvertently.

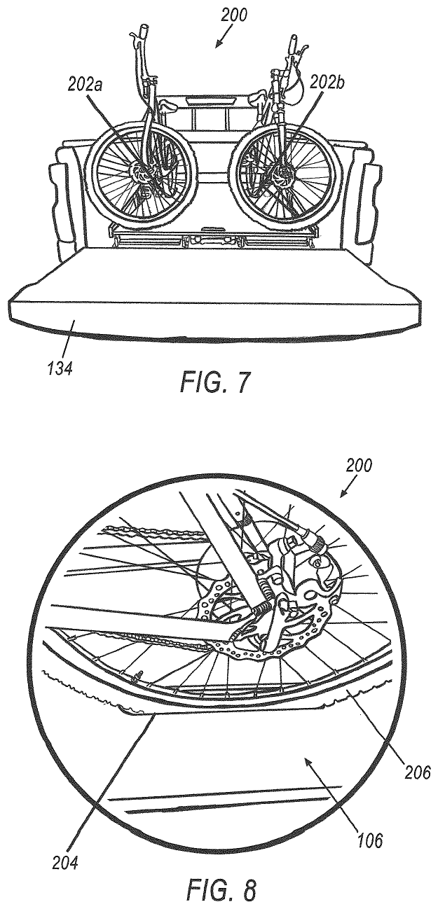

FIG. 7 depicts a bike tray 200 which is a second exemplary embodiment of the system 100. The bike tray embodiment 200 includes a two place bike holder that can be easily deployed from the system 100 without any additional hardware being required. A pair of bicycles 202a and 202b are mounted to the tray 104 in the back end of a vehicle 102. The tray 104 has two elongated slots 204 cut out of it and they are operable to receive the tires of the bikes. The slots 204 are designed to receive the rear tire of a mountain bike, or other type of bike, and the slots 204 can be tailored to accommodate a variety of bike tires. The roller sections 122a and 122b are configured such that the rear tire 206 of a bike can drop down all the way to the rearward ramp plate/step plate 164a and 164b. This arrangement allows for the tire 206 to seat downward into the slot 204 and provide greater support for a bike 202 during transport.

Referring now to FIG. 8, this view is a close up of bike tire slot 204. One can see that the slot 204 is deep enough that it keeps the back of the bike from moving fore-aft or side to side. It will be appreciated that a slot could be located in the tray 104 at the front so as to accommodate the front tire of a bike.

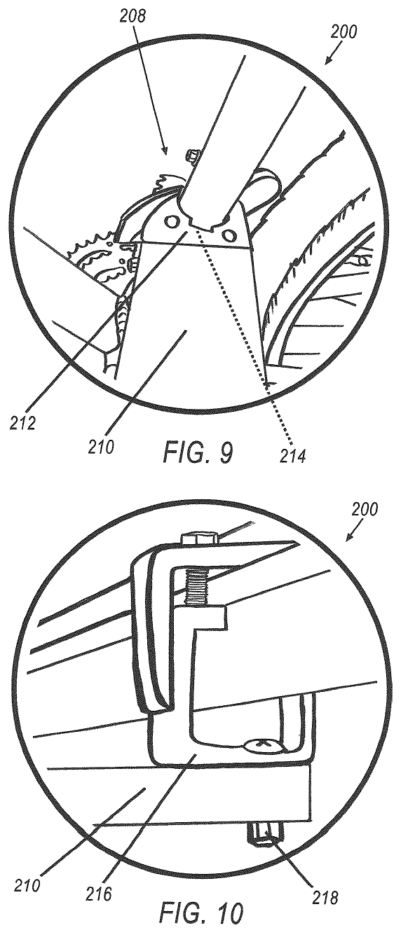

Referring now to FIG. 9, the bike embodiment 200 further includes a bike anchor 208 that is operable to hold the bike in a steady position during transit. The anchor includes a crossbar 210 with a rubberized clamp 212 located on the end of it. The rubberized clamp 212 may be secured to the crossbar 210 utilizing a screw or other fastener 214.

Referring now to FIG. 10, it is a close up of the crossbar 210 mounted to the bottom of the middle tonneau clamp 216 utilizing a traditional hardware 218. The middle tonneau clamp 216 can slide fore/aft to line up perpendicular to the center of the bike's frame tube. When the middle tonneau clamp 216 is positioned and secured, the bike anchor 208 rotates out from the bed rail and the rubberized clamp 212 is placed on the bike tube. The anchor 208 has a single point mounting via the hardware 218 to the middle tonneau clamp 216. This allows for the bike anchor 208 to be rotated under the box rail when not in use.

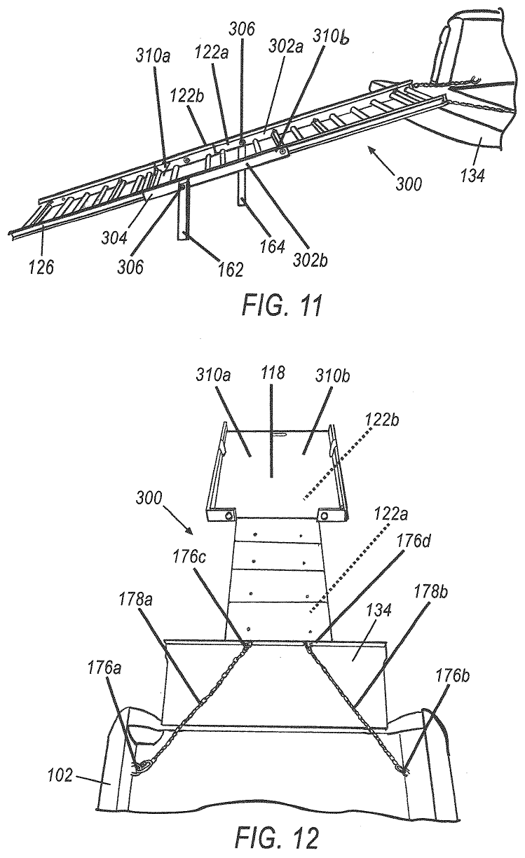

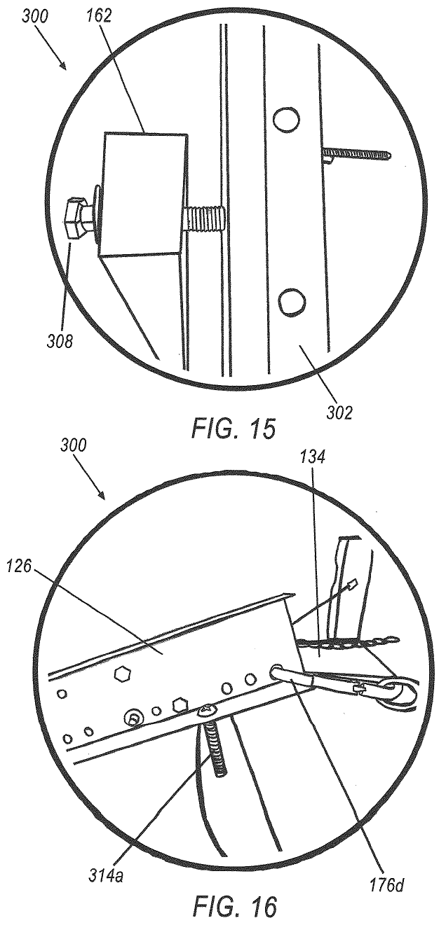

The third exemplary embodiment of the system 100 is the ramp base assembly 300. The assembly 300 utilizes much of the same parts from the first exemplary embodiment 100. Referring now to the overall view FIG. 11, a ramp assembly 300 is presented. The upper roller section 122a is connected to the lower roller section 122b via the connector board/table leg 302a and 302b. As part of the connector board/table leg 302a and 302b assembly are the ramp leg short 162 and the ramp leg long 164. They are secured to the ramp base 304 with hardware 306 such as a ½ in bolt 308, washer nut. The close-up depiction of the bolt on its way through the ramp leg short 162, the connector board/table leg 302a and the roller section 122aa can be seen in FIG. 15. Finally, holes in roller sections 122a and 122b and connector board/table leg 302a and 302b match up. This allows them to receive the left and right securing pins 310a and 310b.

Referring now to the FIG. 12, shown is a top view with the ramp assembly 300 positioned at the back center of the tailgate 134. The ramp assembly 300 is held tightly in place by a combination of carabiner 176a and 176b on the lower tie down of the truck, attached to a chain 178a and 178b, to another Carabiner 176c and 176d that goes through a hole on the upper roller section 122a. This setup will automatically center the ramp 300 and keep it from falling off the Tailgate 134.

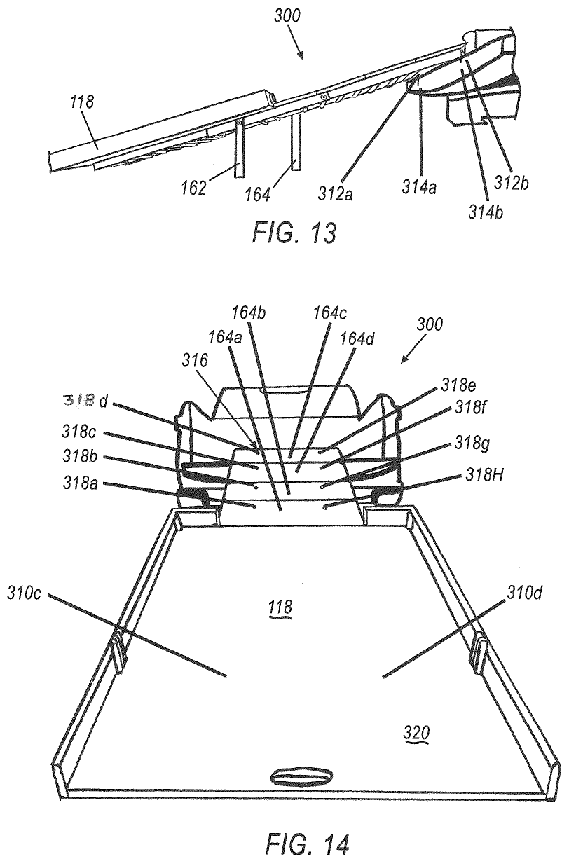

Referring now to side view FIG. 13, the ramp assembly 300 is shown. In particular, it shows that to secure the ramp 300 from moving forward, there are two holes 312a and 312b in the upper roller section 122a for receiving the anti forward pins 314a and 314b. This effectively locks the ramp 300 in position so that it does not move when under load. A close-up depiction of this arrangement can be seen in FIG. 16.

Referring back to FIG. 14, the ramp 300 is shown. There are 4 ramp plates/step plate 164a, 164b, 164c and 164d that can be stored under the roller sections 122 in the bed of the truck 102 and constitute the Upper Ramp 316. Each ramp plates/step plate 164a, 164b, 164c and 164d is pre-drilled to line up with holes in the upper roller section 122a. They are secured using one inch ramp plate bolts and nuts 318a, 318b, 318c, 318d, 318e, 318f, 318g and 318h. The Lower Ramp 320 is the tray table 118 which has two pre-drilled holes that match up with holes in the top of the lower roller section 122b. This allows them to receive the left and right securing pins 310c and 310d.

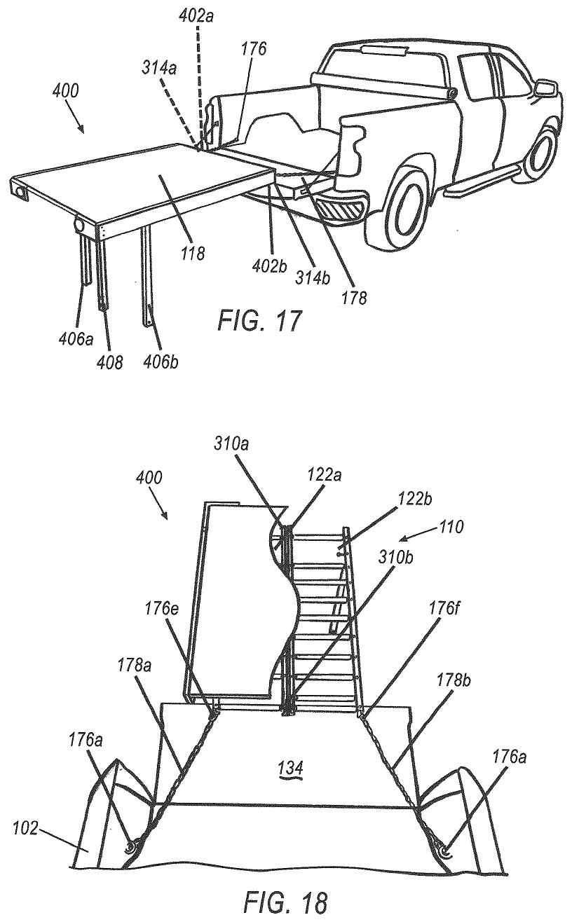

The fourth exemplary embodiment of the system 100 is the table system 400 as shown in FIGS. 17 and 18. The table 400 system utilizes similar parts from the tray drawer 104, bike system 200, and ramp 300. FIG. 17 is the table 400 system shown in the upright and deployed position where it is substantially horizontal and adjacent to the tailgate 134. The table system 400 uses the table 118 which is held tightly in place by a combination of carabiners 176a and 176b on the lower tie down, attached to a specific amount of chain 178a and 178b, to another Carabiner 176e and 176f that goes through a hole on the upper roller section 122a. This setup will automatically center the table and keep it from falling off the Tailgate 134. The table 118 is secured and is kept from moving forward by two holes 402a and 402b in the upper roller section 122a that receive pins 314a and 314b. This effectively locks the ramp 400 into position. A close-up depiction of this can be seen in FIG. 16 which also depicts how it is supported by the connector board/table legs 406a and 406b and middle leg 408. At the tailgate end 116 it utilizes the same technique used for the ramp to keep it from moving forward using the anti-forward pins 314a and 314b. See FIG. 13 for a close up of this arrangement.

FIG. 18 is the top view and shows roller sections 122a and 122b positioned roller down just off the end of the tailgate 134. The roller sections 122a and 122b are pushed together until holes are aligned. Securing pins 314a and 314b connect the two roller sections 122a and 122b together at the front and back. The chains 178a and 178b are connected to the Lower Tie Down in the pickup box via the carabiner 176a, 176b on the last link on both sides. The table carabiners 176e and 176f on the other end of the chain 178a and 178b are attached to a provided hole on each of the roller sections 122a and 122b. At this point one would pull the chains tight to center the structure onto the tailgate 134. The attached chain and the anti forward pins prevent the table from moving thus creating a stable base.

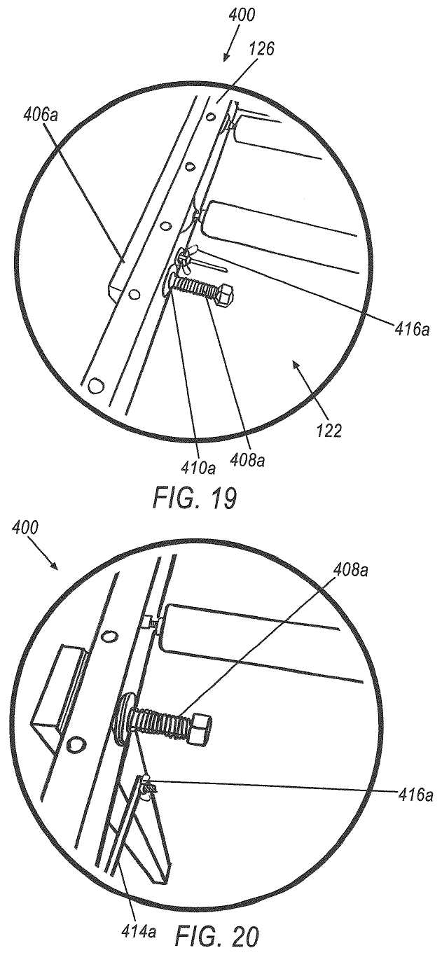

FIG. 19 is a close up view of the connector board/table legs 406a and 406b and how they are stored in the C Channel of the roller sections 122a and 122b. They are held by compressible springs 408a and 408b on a ½ inch bolt and washer 410a and 410b.

FIG. 20 is a perspective view showing that when the connector board/table legs 406a and 406b are pulled out, it compresses the spring 408a and is allowed to swing down and lock into position for each roller section 122a and 122b. Leg braces 414a and 414b are stored/mounted on the roller section 122a and 122b via the hardware with wingnut 416a. When it is removed the leg braces 414a and 414b swing down to line up with a pre-drilled hole connector board/table leg 406a and 406b. The hardware with wingnut 416 is inserted into the pre-made hole and hand tightened. The table 118 can then be placed upside down onto the table base.

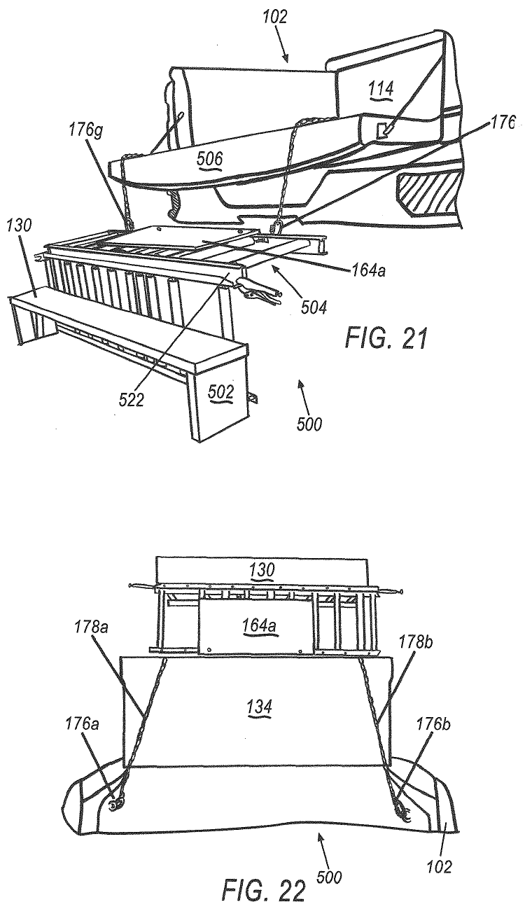

The fifth exemplary embodiment of the system 100 is the step assembly 500 which is shown deployed in FIG. 21. The step assembly 500 is an assist to help people step up into the bed of a truck 102. The step assembly uses similar components as discussed in systems 200, 300 and 400. FIG. 21 is perspective view that shows three steps for accessing the bed of the truck. The first step 502 is the anti fallout board/step 130 that has been removed from the front of the bed of the truck 102 and flipped over onto its legs. The second step 504, known as step plate 164a is positioned just below the tailgate 134. The tailgate 134 itself serves as a third step 506.

The top view of the step assembly 500 is shown in FIG. 22, utilizing the carabiners 176a and 176b and the chains 178a and 178b they are attached to the lower tie down on each side of the pickup box 114. FIG. 17 shows that the chain 178 drapes over the tailgate 134 down to the step carabiners 176g and 176h.

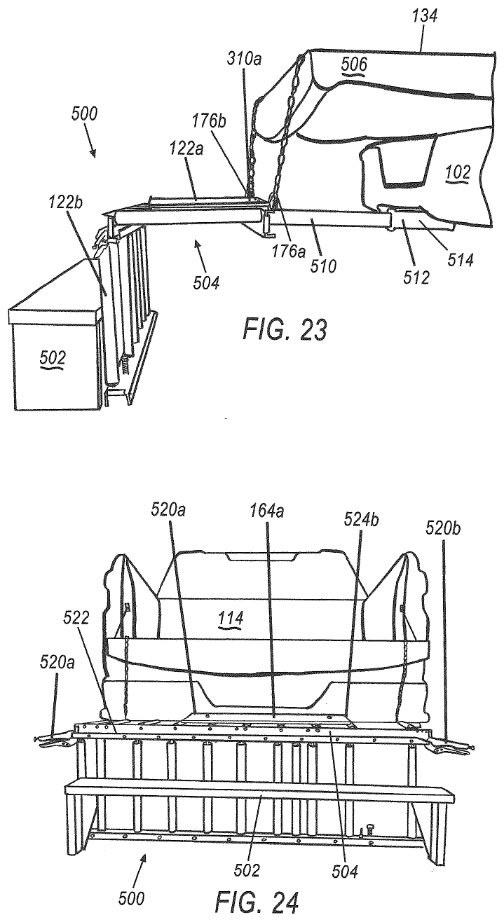

Referring to FIG. 23, this side view shows a Reese Hitch stabilizer bar 510 slid into the hitch 512 and pinned with the hitch pin 514. Roller section 122a is placed horizontally under the tailgate 134 with the rollers out. Carabiners 176g and 176h are attached to the provided hole on the roller section 122a and 122b. Roller section 122b is vertically placed directly under roller section 122a and it abuts against the first step 502. Roller section 122a will neatly land on the one side in the channel of roller section 122b. Having roller section 122a horizontal, this permits the securing pin 310a to be placed through the provided hole on roller section 122a and into a hole in the Reese Hitch stabilizer bar 510. This arrangement helps lock the second step 504 firmly into position relative to the truck 102.

Referring to the back view FIG. 24 of the step system 500, two clamps 520a and 520b are shown holding together the sections 122a and 122b where they come together in a channel 522. The step plate 164a is placed on roller section 122a and secured with step plate bolts 524a and 524b through the provided holes. The second step 504 is now assembled. The anti fallout Step 130 that was previously used as an anti fall out board, is now used as the first step 502, and is shown placed in front of the second step 504.

FIG. 25 is the pull out tray assembly 104 shown deployed with goods 600 in the tray. The tray is shown extending from the bed of a truck 102 and goods such a cooler can be stored in a first compartment 602, while groceries, packages and the like are stored in a second compartment 604. Once the tray is filled, the operator can push the tray towards the cab of the truck 102 and the tray will easily close at which time the tailgate 134 can be closed. This will lock the tray in place.

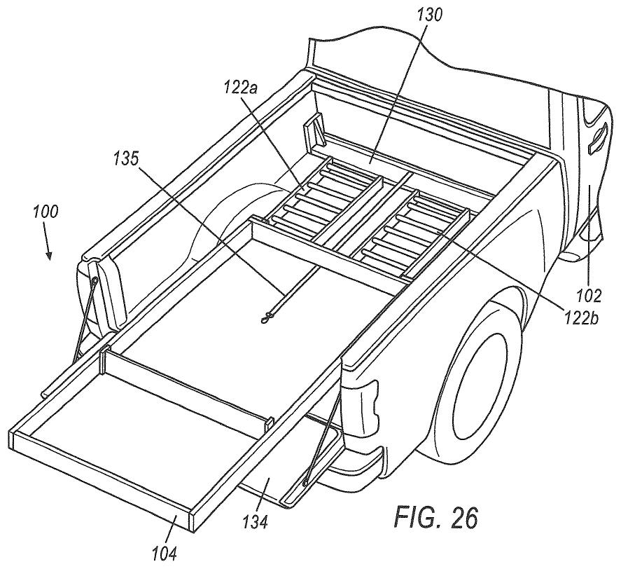

FIG. 26 is a top view of the tray shown partially pulled out showing an empty tray with the rollers underneath. The tray 104/rolls relative to the set of rollers 122a and 122b and the strap 135 is connected to the tray 104 on one end, and the other end of the strap 135 is connected to the fall out/board step 130. This arrangement creates a stop and prevents the tray 104 from disengaging from the truck 102.

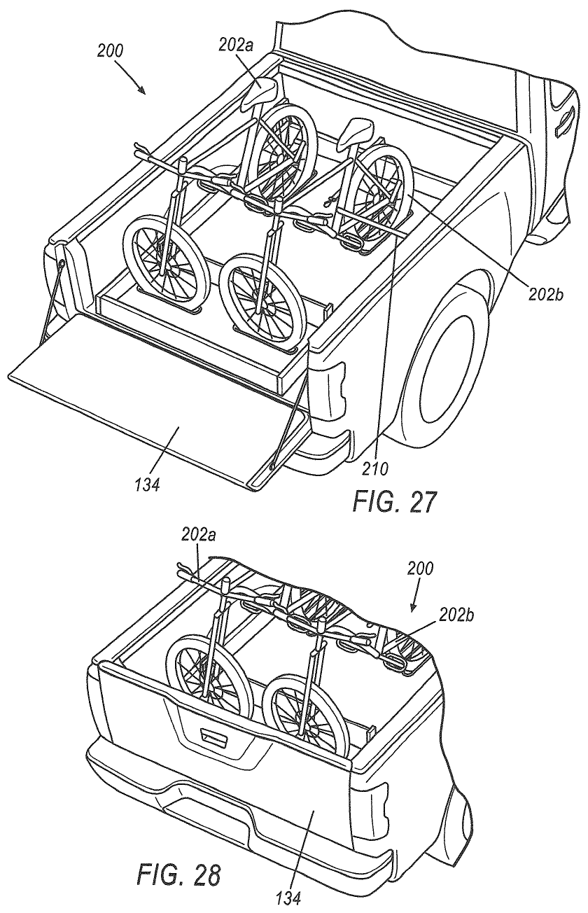

FIG. 27 is the bike assembly 200 showing bikes 202a and 202b mounted to the tray 104. The tailgate 134 is down and this represents a loading position. The rear tires of the bikes have been mounted in the slots 204 and the front tires are mounted in transversely located slots to help lock the bikes in place. A connecting anchor 208 secures the bike to the tray so that the bike maintains an upright position during transit.

FIG. 28 is a partial perspective view showing a pair of bikes mounted to the tray 104. The tailgate 134 has been closed and the bikes are in their stowed and ready for transport.

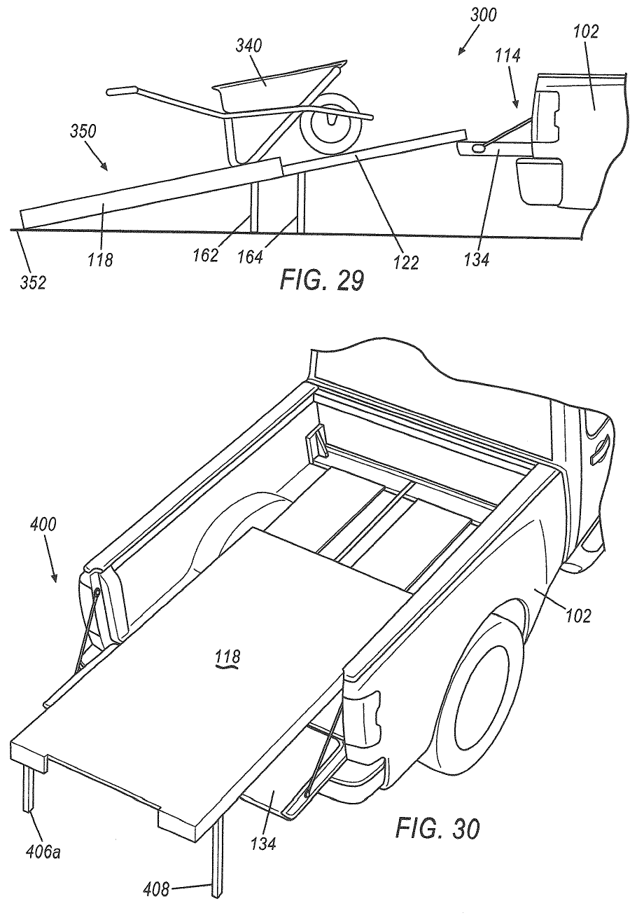

FIG. 29 is a side view showing the ramp assembly 300 deployed with an object, such as a wheelbarrow 340, moving up the ramp 350. The ramp 350 is secured to the back of the tailgate 134 while resting on the tailgate. The ramp 350 has legs positioned in the middle to provide support when goods are transferred up the ramp 350. The ramp 350 extends from the tailgate 134 to the ground 352 at a modest slope for ease of entry of items into the truck bed 114.

FIG. 30 is a perspective view showing the table assembly 400 with the table 118 partially deployed as it moves over past the tailgate 134 and towards the deployed position. The table 118 may be used in this position or it may be pulled out further to where it is fully extended.

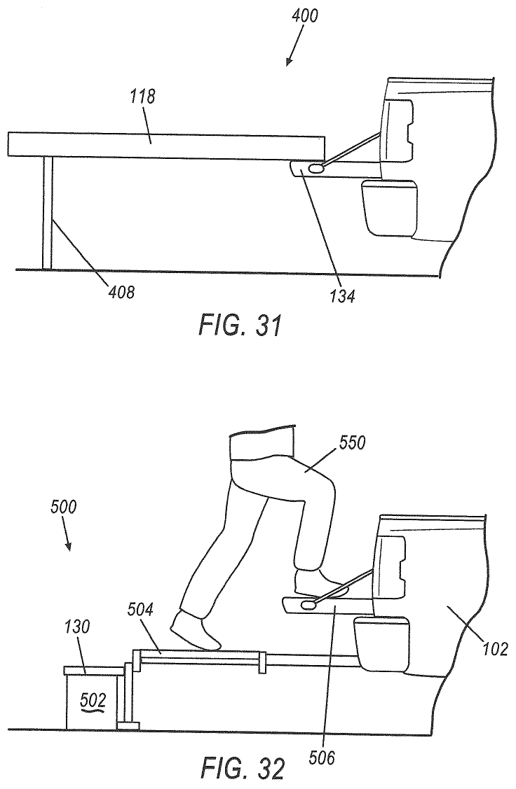

FIG. 31 is a side view showing the table 118 fully deployed and resting on the tailgate 134. The table 118 is level and ready for use for tail gaiting, construction projects, games, and the like.

FIG. 32 is a side view of the step assembly 500 showing the steps 502, 504 and 506 deployed and a person 550 traversing up into the back of a truck. The steps 502 and 504 can be collapsed and repositioned back into the truck bed 114.

The system 100 is operable to be manipulated so that a tray system 104 can be deployed, or a bike transport system 200 can be deployed, a ramp system 300 can be deployed, a work table system 400 can be deployed, or a step system 500 can be deployed. The method of transitioning the multi-purpose system 100 from the aforementioned systems is all accomplished without adding any additional components. The system is transformative where the components from one system can be deployed to aid in the use of another system. The system does not permanently mount to the bed of a truck and does not require the operator to drill any holes in the truck.

The system 100 components that make up the tray, bicycle holder, access ramp, table and step take up approximately 11% of the cargo area of a short box of a vehicle. Further, system 100 is configured so that it can be transferred between like truck beds without tools. In addition, the system 100 is designed such that the tray, bike holder, ramp, table and step can be assembled and dis-assembled without use of tools once installed in the truck bed. Also, by combining roller sections 122 the length of the ramp can increase to 10 feet, and when extended, the pitch of the ramp is approximately 20 degrees from ground. Such provides for ease of delivery of materials and objects to the bed of the vehicle.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted.

Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the disclosure and does not pose a limitation to the scope of the disclosure unless otherwise claimed. No language in the specification should be construed as indicating any non-claimed element as essential to each embodiment of the present disclosure.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the disclosure have been described for illustrative and not restrictive purposes, and alternative embodiments will become apparent to readers of this patent. Accordingly, the present disclosure is not limited to the embodiments described above or depicted in the drawings, and various embodiments and modifications can be made without departing from the scope of the claims below.

1. A multi-purpose tray system that can be deployed in a bed of a vehicle without permanently affixing the system to the bed of the vehicle, the tray system being operable to be removed from the bed of the vehicle, the tray system comprising:
A first configuration is a cargo tray where the system includes a pull out tray, the tray having compartments for storing articles, the tray moves on at least one set of rollers that are held in place relative to the bed of a vehicle, the tray includes a strap that holds the tray in place relative to the bed of the vehicle which prevents the tray from disconnecting from the vehicle;
A second configuration is a bicycle holder where the tray includes slots for receiving tires of a bicycle, the second configuration including an anchor that holds the bicycle in place relative to the bed of the vehicle;
A third configuration is an access ramp, said third configuration deploys the tray and the rollers and they extend from the bed of the vehicle, at least one leg extends from the roller or the tray to provide support, the rollers are connected to a tail gate of the vehicle;
A fourth configuration is a table where the tray extends from the truck bed to create a table, the table is supported by at least one leg and by the tail gate; and
A fifth configuration is a step for assisting access to the bed of a truck.

2. The multi-purpose tray system as claimed in claim 1, wherein the components that make up the tray, bicycle holder, access ramp, table and step comprise approximately 11% of a cargo area of a short box of a vehicle.

3. The multi-purpose system as claimed in claim 1, where the system is configured so that it can be transferred between like truck beds without tools.

4. The multi-purpose system as claimed in claim 1, wherein said tray, bike holder, ramp, table and step can be assembled and dis-assembled without use of tools once installed.

5. The multi-purpose system as claimed in claim 1, wherein combining roller sections increases a length of the ramp to 10 feet, and when extended, a pitch of the ramp is approximately 20 degrees relative to a ground portion in which the ramp sits upon.

6. The multi-purpose system as claimed in claim 1, wherein the first configuration cargo tray includes a step, a safety system for holding the tray in place relative to a vehicle, a midstop, a backstop, and a cushion material.

7. The multi-purpose system as claimed in claim 1, wherein the second configuration bicycle holder is operable to hold at least two bicycles.

8. The multi-purpose system as claimed in claim 1, wherein the second configuration bicycle holder anchor includes a crossbar with a first end and a second end. The first end is connected to a clamp that engages a portion of a bicycle, the second end is connected to the vehicle.

9. The multi-purpose system as claimed in claim 1, wherein the third configuration is the ramp, the ramp further includes a connector that is operable to connect the first set of rollers to a second set of rollers, at least one leg is connected to the connector and extends underneath the set of rollers.

10. The multi-purpose system as claimed in claim 1, wherein the third configuration is the ramp, the ramp is operable to have the tray sit on top of the ramp.

11. The multi-purpose system as claimed in claim 1, wherein the third configuration is the ramp which includes at least one chain connected at one end to the vehicle, and at another end connected to the first set of rollers.

12. The multi-purpose system as claimed in claim 1, wherein the fourth configuration is the table, the table includes a first anchor and a second anchor, the first anchor is a chain connected to an inside portion of the vehicle's bed and to an end of the table, the second anchor is another chain connected to another inside portion of the vehicle's bed and to the end of the table.

13. The multi-purpose system as claimed in claim 1, wherein the fourth configuration is the table, the table includes a plurality of legs extending from the underside of the table, the legs have a length such that when installed, they are operable to make the table substantially even with a height of a tailgate of the vehicle.

14. The multi-purpose system as claimed in claim 1, wherein the fourth configuration is the table, wherein two rollers are placed side by side, and the tray is located on top of said rollers, the tray has a portion that extends downward and overlaps the two rollers.

15. The multi-purpose system as claimed in claim 1, wherein the fifth configuration is the step, wherein the step includes a first step, a second step, and a third step, the first step is comprised of a step member that can be located in a front of the bed and used as a stop to prevent the tray from advancing too far forward in the bed of a vehicle, the second step is the first roller positioned horizontally and a second roller positioned on its side, said rollers are held in place by a clamp, the third step is a tailgate of a vehicle, a chain is connected between the second and third steps, a bar extends from the vehicle and is connected to the first roller.

16. The multi-purpose system as claimed in claim 1, wherein the fifth configuration is the step that can be unassembled and relocated within the bed of a truck.

17. A multi-purpose system for use with a vehicle, the system is operable to be configured to provide:
a drawer;
a multi-place bike holder;
a ramp;
a table; and
a step,
wherein the system can be stored in a bed of the vehicle, and removed and stored in a bed of another vehicle, without permanently attaching the system in either vehicle.

18. The system of claim 17, further comprising a set of rollers that are located underneath the drawer, the drawer is operable to move from a stored position to a deployed position, the drawer includes at least two compartments that are separated by a board, the board is removeable so as to permit the multi-purpose system to be converted to the multi-place bike holder, the drawer may be removed from a bed of a vehicle for use as a ramp, the drawer may be removed from the bed of a vehicle for use as a table, the system may be reconfigured to provide a step for providing enhanced access to the bed of the vehicle.

19. A multi-purpose system for use with a vehicle having a method of operating including all of the following steps:
sliding a drawer out of a bed of a vehicle, the drawer configured to have articles stored therein;
positing the drawer to a stored position, and providing locations for receiving a plurality of bikes and an anchor for securing the bikes;
deploying a ramp by extending it from the bed of the vehicle;
converting the drawer into a table, and extending legs to support the table; and
reconfiguring the drawer to become a step.

20. The system of claim 19, wherein the method includes removing the multi-purpose system from the bed of a vehicle, and placing it in the bed of another vehicle, without the use of any tools or drilling any holes in the vehicle.
